(19) United States
(12) Patent Application Publication
(10) Pub. No.: US 2001/0011721 A1
(43) Pub. Date: Aug. 9, 2001

(54) Device for fixing a lifeline against a wall

(75) Inventors: Pierre-Georges Pelofi, Montpellier (FR); Pascal Lara, Vierzon (FR)

Correspondence Address: GREENBLUM & BERNSTEIN, P.L.C., 1941 ROLAND CLARKE PLACE, RESTON, VA, 20191, US

(73) Assignee: DALIOZ FALL PROTECTION, Vierzon (FR)

(21) Appl. No.: 09/775,566

(22) Filed: Feb. 5, 2001

(30) Foreign Application Priority Data
Feb. 3, 2000 (FR) 00.01375

(51) Int. Cl. H02G 1/08

(52) U.S. Cl. 254/134.3 R

(57) ABSTRACT

A device for fixing a lifeline against a wall of a building includes a shackle with two flanges, a clip cut and bent to feature a channel section the edges of which are extended by lugs and two sleeves featuring a longitudinal slot enabling them to be mounted on the lifeline. Each sleeve is conformed to feature a cylindrical part which can be inserted between the channel section and the lifeline and extended by a part which becomes thinner towards its free end. The flanges of the shackle and the lugs each include a hole. The holes are aligned so that a nut-and-bolt fastener can be passed through them.

### BACKGROUND OF THE INVENTION

1. Field of the Invention

The present invention relates to a device for fixing a lifeline against a wall. Description of the prior art The invention relates more particularly to lifelines consisting of a cable or a rod fixed horizontally to the facade of a building, an acroterion or roof timbers and substantially enabling the attachment of a mobile element to which is attached one end of a cable whose other end is connected to a harness or to a belt in order to protect a worker working along the construction from falling accidentally.

Fixing members which are embedded in the facade of the building are generally attached to the lifelines.

Consequently, a sufficient number of such members must be provided at installation time and the members cannot be changed without partly or totally demounting the assembly.

One object of the invention is to provide a device that remedies this disadvantage.

### SUMMARY OF THE INVENTION

The device in accordance with the invention includes a shackle with a core and two flanges and whose core is adapted to be fixed to a member embedded in the wall, a clip cut and bent to feature a channel section one edge of which is extended by a lug bent so that it is perpendicular to the axis of the channel section and the other edge of which, in the vicinity of the other end, is extended by a lug parallel to the first lug, and two sleeves made from a material with some elasticity and featuring a longitudinal slot enabling them to be mounted on a lifeline, each sleeve being conformed to feature a cylindrical part adapted to be inserted between the channel section and the lifeline and extended by a part which becomes thinner towards its free end, the flanges of the shackle and the lugs each including a hole, the holes being aligned so that a nut-and-bolt fastener can be passed through them.

A fixing device of the lifeline can therefore be replaced, added or demounted without having to demount the lifeline.

In accordance with one detail of construction, the flanges of the shackle are disposed between the lugs.

Finally, in accordance with a final feature, one of the holes in one of the lugs and the corresponding hole in the flange of the shackle are square and the bolt has a square-section shoulder near its head which can be inserted into the holes. The bolt is therefore held when the nut is tightened, which facilitates fixing the clip to the shackle.

The invention will now be described in more detail with reference to one particular embodiment shown by way of example only in the accompanying drawings.

### BRIEF DESCRIPTION OF THE DRAWINGS

FIG. 1 is an exploded perspective view of a device according to the invention.

FIG. 2 is a perspective view of the clip to a larger scale.

FIG. 3 is a perspective view of a sleeve to a larger scale.

FIG. 4 is a perspective view of the assembled device.

### DETAILED DESCRIPTION OF THE PREFERRED EMBODIMENT

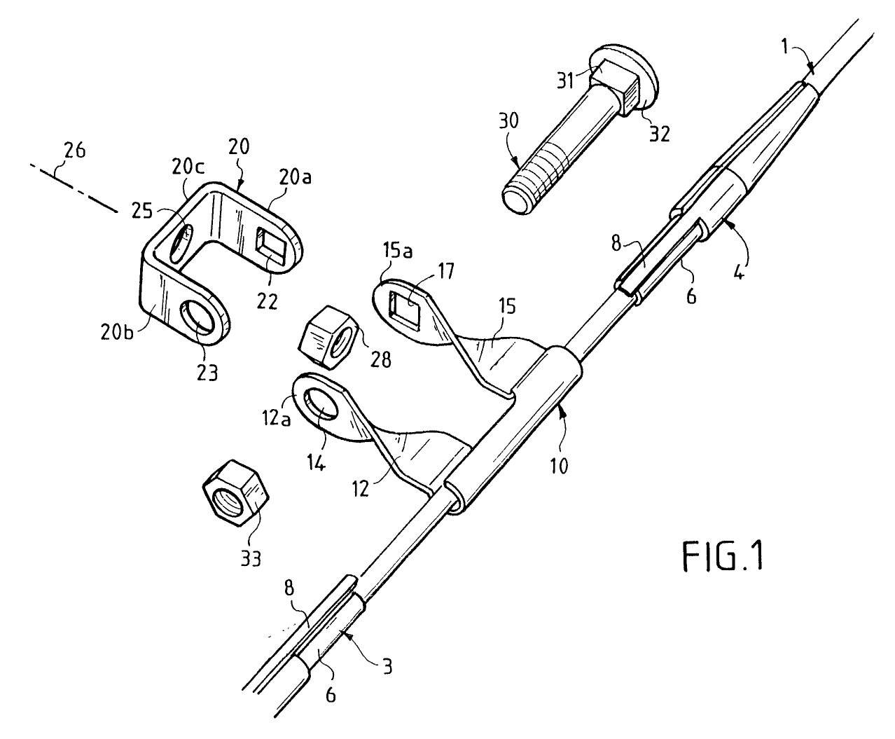

FIG. 1 shows a lifeline 1 consisting of a rod or a cable made of metal and fixed horizontally against a wall 2.

Two plastics material sleeves 3 and 4 are engaged over the rod 1 and each sleeve has a frustoconical part 5 extending from one end 5a which constitutes the smaller base to a shoulder 5b which constitutes the larger base and is extended by a cylindrical part 6.

The plastics material of the sleeves is an elastic material and a slot 7 is provided, extending from the end 5a to the free end of the cylindrical part 6. The sleeves can therefore be mounted anywhere on the rod 1 by opening the slot 7 elastically.

A tongue 8 is provided on a portion of the cylindrical part 6.

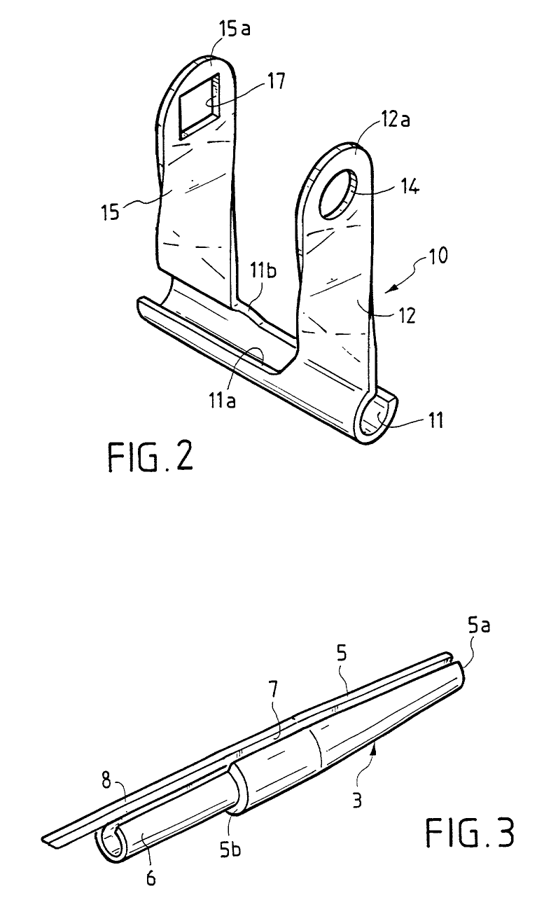

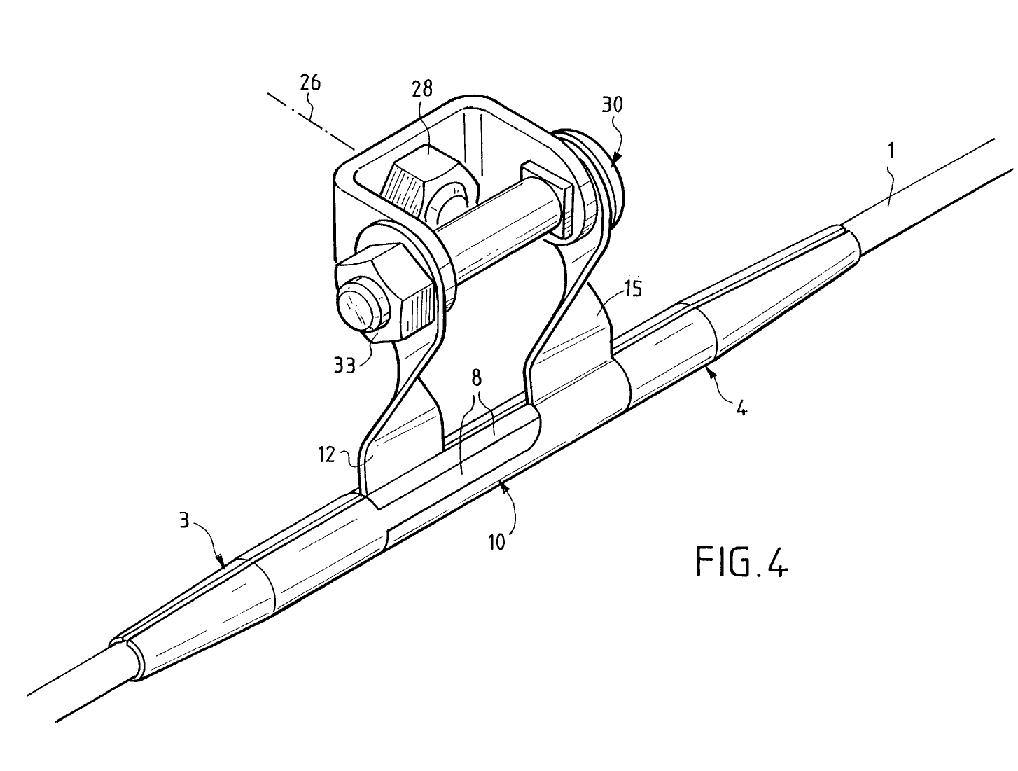

The fixing device includes (see FIG. 2) a clip 10 made from a metal with some elasticity which is cut and shaped to feature a channel section 11 whose inside diameter is slightly smaller than the outside diameter of the parts 6.

The channel section has a cross section in the shape of a circular arc subtending an angle of approximately 270° and is extended along one edge 11a at one end by a lug 12 which is bent so that its free end 12a is in a plane perpendicular to the axis of the channel section 11, said lug incorporating a circular hole 14.

Along its other edge 11b, and in the vicinity of its end opposite that provided with the lug 12, the channel section 11 is extended by a second lug 15 which is bent so that its free end 15a is perpendicular to the axis of the channel section 11. The two lugs 12 and 15 are parallel.

The lug 15 has a square hole 17 in it near its free end and the holes 14 and 17 are aligned.

Finally, the device is completed by a shackle 20 which has two flanges 20a and 20b and a core 20c. The flange 20a includes a square hole 22 with the same dimensions as the hole 17 and the flange 20b includes a hole 23 corresponding to the hole 22.

The core 20c includes a hole 25 for a threaded rod embedded in the wall of the building and receiving a nut 28.

To mount the lifeline horizontally along a building, shackles 20 are fixed to the wall of the building at regular intervals by nuts 28 screwed onto the free ends of threaded rods 26 buried in the thickness of the wall of the building and whose free ends pass through the holes 25.

The sleeves 3 and 4 are then fitted so that the free ends of the parts 6 are face-to-face with a gap between said ends, the clip 10 is then fitted over the rod 1, and the sleeves 3 and 4 are then pushed so that the cylindrical parts 6 are inserted in the channel section 11 and the free ends of the tongues 8 abut against the shoulder 5b and lie in the open part of the channel section 11. The clip 10 is then placed so that the lugs 12 and 15 are on respective opposite sides of the flanges 20b and 20c. The shackle and the clip are fastened together by a bolt 30 which has a head 32 with a square shoulder 31. The bolt passes through the holes 17, 22, 23 and 14 and receives a nut 33. The shoulder 31 is inserted into the holes 17 and 22.

Of course, the invention is not limited to the embodiment that has just been described and shown. Many modifications of detail can be made thereto without departing from the scope of the invention.

There is claimed:

1. A device for fixing a lifeline against a wall of a building, including a shackle with a core and two flanges and whose core is adapted to be fixed to a member embedded in said wall, a clip cut and bent to feature a channel section one edge of which is extended by a lug bent so that it is perpendicular to the axis of said channel section and the other edge of which, in the vicinity of the other end, is extended by a lug parallel to the first lug, and two sleeves made from a material with some elasticity and featuring a longitudinal slot enabling them to be mounted on a lifeline, each sleeve being conformed to feature a cylindrical part adapted to be inserted between said channel section and said lifeline and extended by a part which becomes thinner towards its free end, said flanges of said shackle and said lugs each including a hole, said holes being aligned so that a nut-and-bolt fastener can be passed through them.

2. The device claimed in claim 1 for fixing a lifeline against a wall of a building, wherein said flanges of said shackle are disposed between said lugs.

3. The device claimed in claim 1 for fixing a lifeline against a wall of a building, wherein one of said holes in one of said lugs and the corresponding hole in said flange of said shackle are square and said bolt has a square-section shoulder in the vicinity of its head adapted to be inserted into said holes.
